(19) United States
(12) Patent Application Publication
(10) Pub. No.: US 2012/0247790 A1
(43) Pub. Date: Oct. 4, 2012

(54) FOAM PROPELLANT SYSTEM

(76) Inventors: Roger Duane Young, Jonesboro, LA (US); Rodney Lane Potts, Jonesboro, LA (US); Mark Jones, Boyce, LA (US)

(21) Appl. No.: 13/437,151

(22) Filed: Apr. 2, 2012

Related U.S. Application Data
(60) Provisional application No. 61/471,132, filed on Apr. 2, 2011.

(51) Int. Cl. A62C 5/02

(52) U.S. Cl. 169/14

(57) ABSTRACT

A foam propellant system can be transportable and used by individuals to suppress a fire or cover a spill area. The system may include a water and/or foam concentrate source and a compressed air source. The water and/or foam concentrate may be mixed together with the compressed air in a mixing tube under pressure producing an expanded fluffy foam that can be propelled into the desired area.

### CROSS-REFERENCE TO RELATED APPLICATION

This application claims benefit under 35 U.S.C. §119(e) of U.S. Provisional Application No. 61471132 filed Apr. 2, 2011, which is hereby incorporated by reference herein in its entirety.

### BACKGROUND OF THE INVENTION

The present invention generally relates to propellant systems, and more particularly, to foam propellant systems.

Disaster areas, for example, fires and oil spills can be partially controlled by the effective use of foam retardants. Typically, foam retardant is employed in large scale drops, for example, by being dropped into a relatively large area by aircraft. However, smaller areas or structures where a fire extinguisher is insufficient to aid can likewise benefit from the use of foam retardants.

As can be seen, there is a need for a foam propellant system that can be transportable and hand-held for individuals' use.

### SUMMARY OF THE INVENTION

In one aspect of the present invention, a foam propellant system, comprises a mixing tube; a first set of jet holes in the mixing tube; a second set of jet holes in the mixing tube; a first chamber coupled to the mixing tube, the first chamber disposed to receive pressurized water/foam concentrate and deliver the pressurized water/foam concentrate through the first set of jet holes into the mixing tube; and a second chamber coupled to the mixing tube adapted to receive compressed air and deliver the compressed air through the second set of jet holes into the mixing tube, wherein the mixing tube is adapted to mix the air and the water/foam concentrate to produce an expanded foam and wherein the mixing tube includes an exit opening to propel the expanded foam.

In another aspect of the present invention, a foam propellant system comprises a mixing tube including holes along a wall of the mixing tube; a first chamber coupled to the mixing tube adapted to provide fluid communication with the holes; a second chamber coupled to the mixing tube adapted to provide fluid communication with the holes; a pressurized foam concentrate source connected to the first chamber; a pressurized air source connected to the second chamber; an intake end of the mixing tube adapted for connection to a fire pump; and a discharge end of the mixing tube, the discharge end disposed to disperse a pressurized expanded mixture of the foam concentrate and air from the mixing tube.

These and other features, aspects and advantages of the present invention will become better understood with reference to the following drawings, description and claims.

### BRIEF DESCRIPTION OF THE DRAWINGS

FIG. 1 is a cross-sectional top view of a foam propellant system in accordance with an exemplary embodiment of the present invention;

FIG. 2 is a cross-sectional end view taken along the line 2-2 of FIG. 1;

FIG. 3 is a side view of a right side chamber used in the foam propellant system of FIG. 1;

FIG. 4 is a side view of a left side chamber used in the foam propellant system of FIG. 1;

FIG. 5 is a cross-sectional partially exploded top view of the foam propellant system of FIG. 1; and

FIG. 6 is a cross-sectional partially exploded end view of the right side of the foam propellant system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claim.

Broadly, an embodiment of the present invention generally provides a foam propellant system that produces an effective foam retardant stream or spray. A combination of water and foam concentrate under pressure may be injected with high speed air through several ports to give total foam expansion. The high speed air used to expand the foam may also propel the foam out of the mixing tube into a hose and nozzle onto a fire, chemical or petroleum spill.

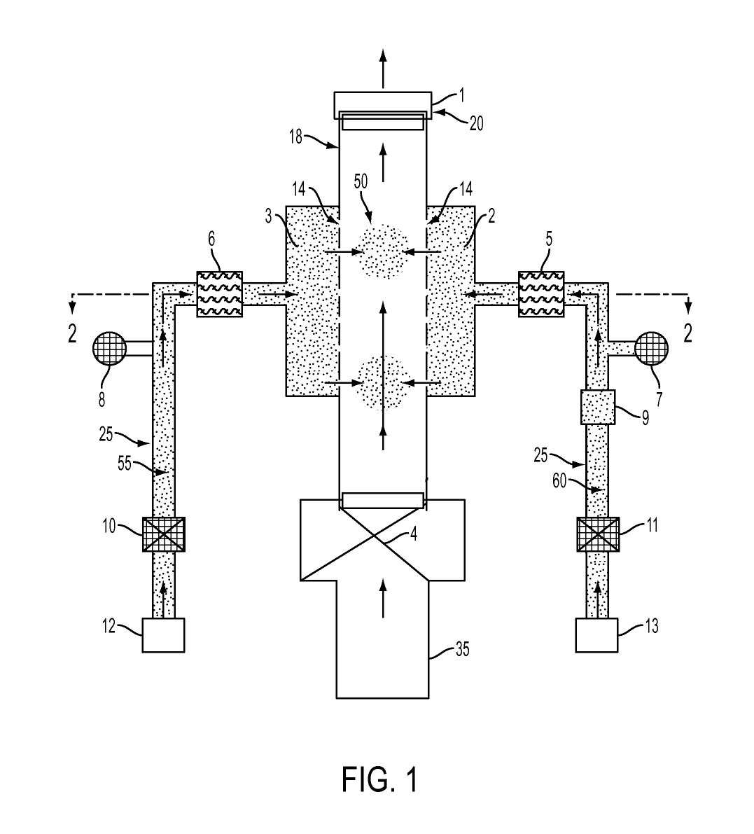

Referring to FIG. 1, a foam propellant system 100 is shown according to an exemplary embodiment of the present invention. The foam propellant system 100 may include a mixing tube 1, a pressurized air chamber 2, and a water/foam concentrate chamber 3. A compressed air source 13 may be connected to the air chamber 2 via tubing 25. A foam concentrate and/or water source 12 may be connected to the water/foam concentrate chamber 3 via tubing 25.

Referring now to FIGS. 1-4, the mixing tube 1 may be adapted to mix and propel an expanded mixture 50 of the water/foam concentrate 55 and compressed air 60. The mixing tube 1 may include a discharge end 20 adapted to connect, for example, by being hard-piped, to a fire hose (not shown). The mixing tube 1 may also include an intake end 35 that may be hard-piped to a fire pump (not shown). The intake end 35 may include a valve 4 may control release of pressurized water (not shown) from the fire pump (not shown) into the mixing tube 1. The mixing tube 1 may include a plurality of jet holes 14 along its wall 18 disposed in fluid communication with the pressurized air chamber 2 and the water/foam concentrate chamber 3. In an exemplary embodiment, the jet holes 14 may be disposed on the mixing tube 1 so that at least some of the holes in fluid communication with the air chamber 2 are transversely aligned (relative to a longitudinal axis of the mixing tube 1 with holes in fluid communication with the water/foam concentrate chamber 3.

In an exemplary embodiment, the mixing tube 1 may typically be a stainless steel pipe having dimensions of about 8 inches long and 1.5 inches in diameter. In some embodiments, the diameter of the pipe may be as large as 3 or even 4 inches, depending on the application. The number and size of the jet holes 14 may meet air flow requirements, typically ranging from about 5 cubic feet per minute (CFM) to 500 CFM. The jet holes 14 may also meet water/foam concentrate flow requirements, typically permitting a flow from about 5 gallons per minute (GPM) to about 500 GPM.

The pressurized water/foam concentrate half of the system 100 may also include a check valve 6, a water pressure gauge 8, and a valve 10. The check valve 6 may be coupled between the water/foam concentrate chamber 3 and the foam concentrate and/or water source 12. The check valve 6 may be adapted to prevent backflow of water and/or foam concentrate back to the source 12. The water pressure gauge 8 may be connected to the tubing 25 between the water/foam concentrate chamber 3 and the foam concentrate and/or water source 12. The valve 10 may be connected to the tubing 25 between the water/foam concentrate chamber 3 and the foam concentrate and/or water source 12 controlling release of water and/or foam concentrate to the chamber 3. The foam concentrate and/or water source 12 may be a pressure pump, for example, a fire pump.

The compressed air side of the system 100 may also include a check valve 5, an air pressure gauge 7, a regulator 9, and a valve 11. The check valve 6 may be between the air chamber 2 and the compressed air source 13. The check valve 6 may prevent back flow of water and/or foam concentrate back to the compressed air source 13. The air pressure gauge 7 may be coupled between the air chamber 2 and the compressed air source 13 adapted measure air pressure within the tubing 25. The regulator 9 may be between the air chamber 2 and the compressed air source 13 adapted to change air pressure within the tubing 25 to correspond to pressure measured by the water pressure gauge 8. The valve 11 may be between the air chamber 2 and the compressed air source 13 and adapted to release compressed air into the air chamber 2 from the compressed air source 13.

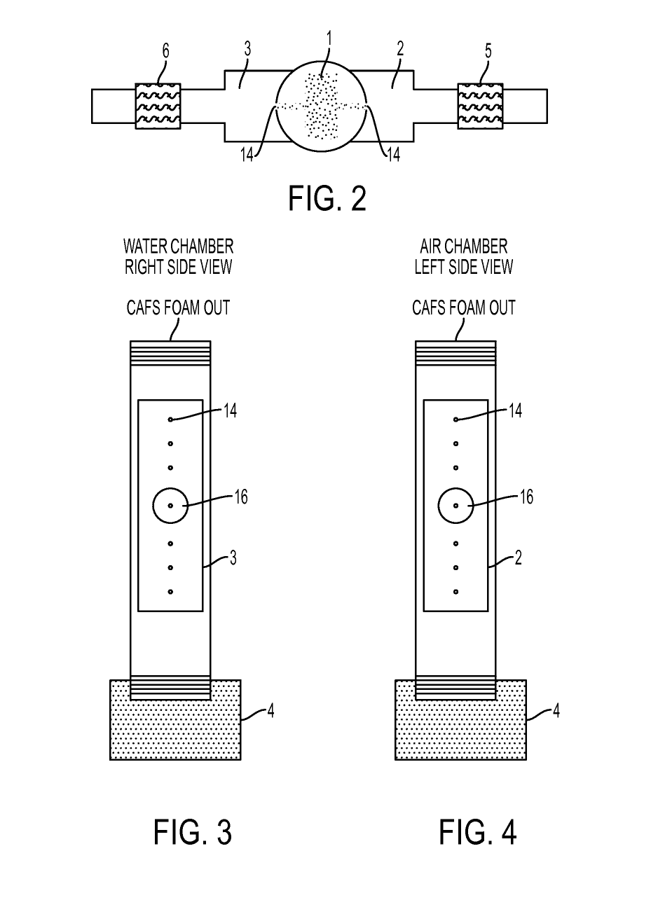

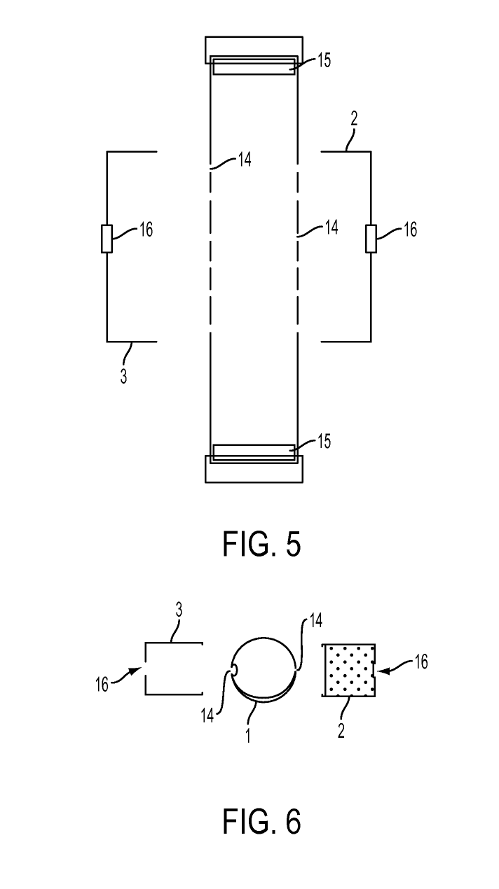

Referring now to FIGS. 2-6, the air chamber 2 and the water/foam concentrate chamber 3 may include a port 16 leading from tubing into respective chambers.

In an exemplary use of the foam propellant system 100, production of high expansion foam 50 may occur within the mixing tube 1 when the fire pump (not shown) is engaged and the valve 10 is opened to allow pressurized water/foam concentrate 55 to flow into the chamber 3 and pass through the jet holes 14 into the mixing tube 1. Compressed air source 13 should be at full pressure and valve 11 opened to allow pressurized air 60 to enter into the air chamber 2 and pass through the jet holes 14 into the mixing tube 1. The water/foam concentrate 55 may become atomized under pressure from the source 12 and may flow into the chamber 3 through the jet holes 14 and into the mixing tube 1. The collision of the atomized water/foam concentrate 55 under pressure and the high speed compressed air 60 may produce a very high expansion fluffy foam 50. The resultant foam 50 may then be propelled from mixing tube 1 through the discharge end 20. Good quality high expansion foam is very effective at extinguishing Class A and Class B fires. The foam propellant system 100 may use, for example Class B foam concentrate. The user may close valves 10 and 11 and open valve 4 to allow a full stream of clear water from the fire pump (not shown) into the fire hose and nozzle.

It should be understood, of course, that the foregoing relates to exemplary embodiments of the invention and that modifications may be made without departing from the spirit and scope of the invention as set forth in the following claim.

What is claimed is:

1. A foam propellant system, comprising:
a mixing tube;
a first set of jet holes in the mixing tube;
a second set of jet holes in the mixing tube;
a first chamber coupled to the mixing tube, the first chamber disposed to receive pressurized water/foam concentrate and deliver the pressurized water/foam concentrate through the first set of jet holes into the mixing tube; and
a second chamber coupled to the mixing tube adapted to receive compressed air and deliver the compressed air through the second set of jet holes into the mixing tube, wherein the mixing tube is adapted to mix the air and the water/foam concentrate to produce an expanded foam and wherein the mixing tube includes an exit opening to propel the expanded foam.

2. The foam propellant system of claim 1 further comprising a discharge end adapted to receive a fire hose.

3. The foam propellant system of claim 2 further comprising an intake end and a valve connected to the intake end, the valve disposed to allow water to enter the mixing tube.

4. The foam propellant system of claim 1 further comprising a first check valve coupled to the first chamber disposed to prevent backflow of water/foam concentrate back to a source of the water/foam concentrate.

5. The foam propellant system of claim 4 further comprising a second check valve coupled to the second chamber disposed to prevent backflow of water/foam concentrate back to a source of the compressed air.

6. A foam propellant system, comprising:
a mixing tube including holes along a wall of the mixing tube;
a first chamber coupled to the mixing tube adapted to provide fluid communication with the holes;
a second chamber coupled to the mixing tube adapted to provide fluid communication with the holes;
a pressurized foam concentrate source connected to the first chamber;
a pressurized air source connected to the second chamber;
an intake end of the mixing tube adapted for connection to a fire pump; and
a discharge end of the mixing tube, the discharge end disposed to disperse a pressurized expanded mixture of the foam concentrate and air from the mixing tube.

7. The foam propellant system of claim 6 wherein the foam concentrate is class B foam.

8. The foam propellant system of claim 6 further comprising a water pressure gauge coupled between the first chamber and the pressurized foam concentrate source.

9. The foam propellant system of claim 8 further comprising a regulator connected between the second chamber and the pressurized air source.

10. The foam propellant system of claim 9 further comprising a valve coupled to the intake end disposed to allow water into the mixing tube.
